(19) United States
(12) Patent Application Publication
(10) Pub. No.: US 2020/0134596 A1
(43) Pub. Date: Apr. 30, 2020

(54) SYSTEM AND METHOD FOR PROCESSING A TRANSACTION

(71) Applicant: MASTERCARD ASIA/PACIFIC PTE. LTD, Singapore (SG)

(72) Inventors: Tobias Puehse, Singapore (SG); Srinath Ravinathan, Singapore (SG); Donghao Huang, Singapore (SG)

(73) Assignee: MASTERCARD ASIA/PACIFIC PTE. LTD, Singapore (SG)

(21) Appl. No.: 16/601,061

(22) Filed: Oct. 14, 2019

(30) Foreign Application Priority Data
Oct. 25, 2018 (SG) 10201809466Y

(51) Int. Cl. G06Q 20/32; G06Q 20/40; G06Q 20/38

(52) U.S. Cl. CPC G06Q 20/3224; G06Q 20/382; G06Q 20/401; G06Q 20/3226

(57) ABSTRACT

The present disclosure relates to payment technology. In one aspect, the present disclosure provides a method of processing a transaction. The method comprises receiving, from a user device, a transaction pairing request, the transaction pairing request comprising user account information of a user account. The method then transmits, to a receiving device, a plurality of transaction identifiers based on the transaction pairing request and receives, from the user device, a selection of one of the plurality of transaction identifiers. The method then associates the user account with a transaction record indicated by the selection of one of the plurality of transaction identifiers.

### TECHNICAL FIELD

The present invention relates generally to payment technology and, in particular, to a system and method for implementing an online payment system.

### BACKGROUND

In conventional arrangements, goods are offered for sale in retail stores to allow consumers to inspect and try out the goods. Once a consumer is satisfied with the goods, the consumer typically brings the goods to a payment counter. A clerk of the store then enters the goods to be purchased into a point-of-sale terminal at the payment counter. Once details of all the goods are entered, the point-of-sale terminal refers to a database of the store to calculate the total sale amount and produce an invoice for that total sale amount. The consumer then pays the store for the goods.

Payment of the goods typically involves presenting a credit card to a payment terminal of the point-of-sale terminal. The card is swiped or scanned and the payment terminal communicates with a payment server to facilitate the payment of the goods using the card.

One problem that a consumer faces when paying using a card is that it may be challenging under certain circumstances, as performing such an action involves multiple steps and likely both hands. Such steps involve, for example, taking out a wallet from its storage place, taking out the card from the wallet, presenting the card to the payment terminal, putting the card back into the wallet, and finally putting the wallet back into its storage place. These actions typically require both hands and may be cumbersome when the consumer is holding shopping bags and looking after kids.

Another problem with the payment terminal is the setting up of that payment terminal. Setting up the payment terminal is typically an arduous process as technicians need to go on-site to install the necessary infrastructure for the payment terminal.

An alternative method of paying for the goods is using cash. However, paying using cash may be even more challenging, as not only the consumer must perform the steps described above when using a card, the consumer must take out the correct amount of cash and receive change for the cash. The change must then be put back into the appropriate storage. Accordingly, cash payment may be more challenging than paying with a card.

At some places, such as a restaurant, paying with the above conventional arrangements typically require a waiter to bring an invoice to the table of the consumer. The consumer then presents the cash or card. In one example, the cash or card is taken away by the waiter. The waiter then returns with the change or card after the payment has been finalized. In another example, the waiter brings a payment terminal to the consumer so that the consumer can present the card to the payment terminal. Bringing a payment terminal to the consumer consumes the consumer's time.

Therefore, there is a need to ameliorate one or more of the above problems.

### SUMMARY

Disclosed are arrangements which seek to address the above problems by replacing the physical payment terminal (e.g., point-of-sale terminals) with an online payment system. The online payment system is implemented using a transaction portal server. The transaction portal server provides an application programming interface (API) that is accessible via a consumer's device (e.g., a mobile phone). When paying for goods, the consumer simply takes out the consumer's device and pays for the goods via the consumer device. Therefore, the consumer does not have to deal with multiple items (e.g., a wallet, a card, cash) when paying for goods.

The online payment system also reduces the risk of a consumer falling for a card scam.

According to a first aspect of the present disclosure, there is provided a system for processing a transaction, the system comprising: at least one processor; and at least one memory including computer program code; the at least one memory and the computer program code configured to, with the at least one processor, cause the system at least to: receive, from a user device, a transaction pairing request, the transaction pairing request comprising user account information of a user account; transmit, to a receiving device, a plurality of transaction identifiers based on the transaction pairing request; receive, from the user device, a selection of one of the plurality of transaction identifiers; and associating the user account with a transaction record indicated by the selection of one of the plurality of transaction identifiers.

According to a second aspect of the present disclosure, there is provided a method of processing a transaction, comprising: receiving, from a user device, a transaction pairing request, the transaction pairing request comprising user account information of a user account; transmitting, to a receiving device, a plurality of transaction identifiers based on the transaction pairing request; receiving, from the user device, a selection of one of the plurality of transaction identifiers; and associating the user account with a transaction record indicated by the selection of one of the plurality of transaction identifiers.

According to a third aspect of the present disclosure, there is provided a non-transitory computer program product having software application programs that are executable by a processor, such that the processor executes the software application programs to perform a method of processing a transaction, the method comprising: receiving, from a user device, a transaction pairing request, the transaction pairing request comprising user account information of a user account; transmitting, to a receiving device, a plurality of transaction identifiers based on the transaction pairing request; receiving, from the user device, a selection of one of the plurality of transaction identifiers; and associating the user account with a transaction record indicated by the selection of one of the plurality of transaction identifiers.

In one arrangement, the transaction pairing request comprises a filter parameter, the filter parameter being any one of location information, merchant details, and time information.

In one arrangement, the system is further configured to: forward, to a merchant device, the transaction pairing request; and receive, from the merchant device, a pairing response indicating whether the transaction pairing request is approved.

In one arrangement, the system is further configured to: initiate a payment to transfer a fund relating to an amount for a product indicated in the transaction record in response to receiving a payment request.

In one arrangement, the system is further configured to: transmit, to the merchant device or the user device, a notification message notifying the merchant or the user respectively of whether the user account is determined to be associated with the transaction record indicated by the selection of one of the plurality of transaction identifiers.

In one arrangement, the system is further configured to: generate a payment token based on a user token of the user account and the transaction record associated with the user account; and transmit the payment token to an acquirer server.

In one arrangement, the system is further configured to: update the transaction record associated with the user account to include a further product and an amount corresponding to the further product.

In one arrangement, the system is further configured to: receive, from a merchant device, data relating to transaction records, wherein the data includes the location information of the transaction records.

In one arrangement, the system is further configured to: receive, from the user device, a request to pay the transaction record associated with the user account; and transmit, to the acquirer server, the transaction request message.

Other aspects of the present disclosure are also disclosed.

### BRIEF DESCRIPTION OF THE DRAWINGS

At least one embodiment of the present invention will now be described with reference to the drawings and appendices, in which:

FIG. 1 is a block diagram of a system for an online payment system in accordance with an aspect of the present disclosure;

FIG. 2 is a flow chart diagram showing the data flow between devices and a transaction portal server in the system shown in FIG. 1;

FIG. 3 is a flow chart diagram of a method of associating a transaction record with a user account by the transaction portal server in the system of FIG. 1;

FIG. 4 shows a flow chart diagram of a sub-process in the method of FIG. 3;

FIG. 5 is a flow chart diagram of a method of processing a payment by the transaction portal server in the system of FIG. 1;

FIGS. 6A to 6D show examples of broadcast transaction records;

FIG. 7 is a flow chart of a method of updating a transaction record that is associated with a user account;

FIGS. 8A and 8B form a schematic block diagram of a computer system upon which a transaction portal server in the system of FIG. 1 can be practiced; and

FIG. 9 shows an example of a computing device to realize the transaction portal server shown in FIG. 1.

### DETAILED DESCRIPTION

### Terms Description

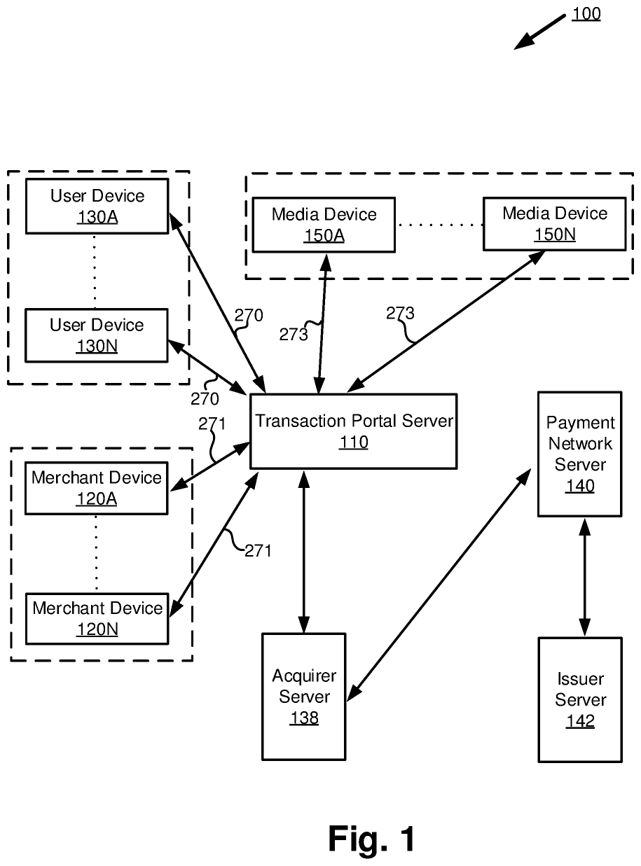

Broadcast transaction record—a transaction record is a record that a transaction portal server 110 (see FIG. 1) has generated and made publicly available to users who are registered with the transaction portal server 110. The broadcast of a transaction record is initiated by a merchant device 120 and is propagated to the transaction portal server 110. In various embodiments below, the transaction record may be propagated via an application programming interface (“API”). Example of APIs include the Representational State Transfer (REST) API, and the like. A transaction record is a listing of goods and/or services (or products) that may be purchased and may also include a broadcast location, an identifier related to the broadcast location, and any other information that may be relevant.

Transaction identifier—a transaction identifier is an identifier associated with a broadcast transaction record. The transaction identifier can be numbers, letters, symbols, and the like. For example, a transaction identifier may be a table number in a restaurant. In another example, a transaction identifier may be a bus stop number in a certain location.

Payment network server—The payment network server is a server that hosts software application programs for processing payment of a transaction request message (which is associated with a broadcast transaction record). The payment network server may be one that is used to process transactions. The payment network server communicates with a token vault (if required), and any other servers (e.g., an issuer server, an acquirer server) to facilitate payment of transaction request messages (associated with broadcast transaction records) generated by the transaction portal server 110. Payment network servers may use a variety of different protocols and procedures in order to process the transaction request messages. Transactions that may be performed via a payment network server include product or service purchases, credit purchases, debit transactions, fund transfers, account withdrawals, etc. Payment network servers may be configured to process transactions via cash-substitutes, which may include payment cards, letters of credit, checks, payment accounts, etc. The payment network server is operated by a payment network operator such as Mastercard®. For example, the payment network server may be Banknet network operated by Mastercard. The payment network operator may be an entity (e.g. a company or organization) who operates to process transactions, clear and settle funds for payments between two entities (e.g. two banks). The payment network server may include one or more computing devices that are used for processing transactions.

Payment account—A financial account that can be used for performing transactions. A payment account may include a payment card, such as a credit card, debit card, prepaid card, savings account, checking account, charge card, membership card, promotional card, frequent flyer card, identification card, gift card, and/or may also relate to a digital wallet (which is also known as an e-wallet). A digital wallet is typically used to store various forms of electronic money to aid in completing e-commerce transactions (or wallet-based transactions). For example, it is possible to link/register a payment card to a digital wallet to perform a wallet-based transaction. It will be understood that each type of these payment account can be used as a method of payment for the online payment system described herein. The payment account includes account information such as an account number, account owner, and the like.

A user account—an account of a user that is registered with the transaction portal server 110. The user account is suitable to be associated with a broadcast transaction record for the purpose of purchasing goods and/or services (or a product). The user account includes a payment account of the user.

A merchant account—an account of a merchant that is registered with the transaction portal server 110. The merchant account is suitable to request a transaction record to be broadcast. The merchant account includes a payment account of the merchant.

Transaction pairing request—a request to associate a user account of a user (who is registered with the transaction portal server 110) with a broadcast transaction record. The transaction pairing request indicates that the registered user would like to be responsible for payment of products listed in a broadcast transaction record by associating the user account of the registered user with the broadcast transaction record.

### Example Implementations

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of devices which form public knowledge through their use. Such should not be interpreted as a representation by the present inventor(s) or the patent applicant that such devices in any way form part of the common general knowledge in the art.

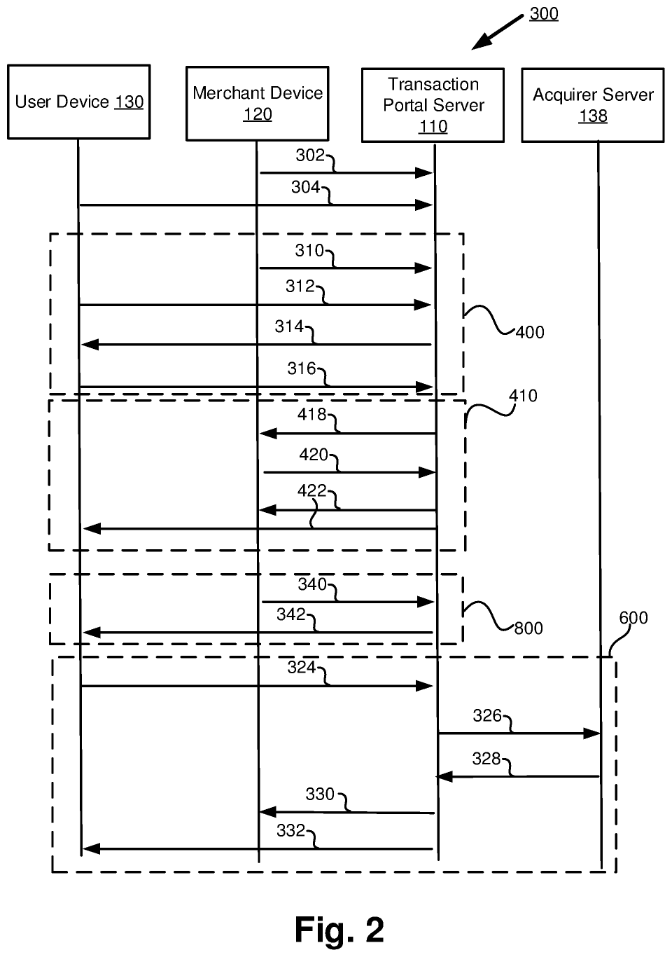

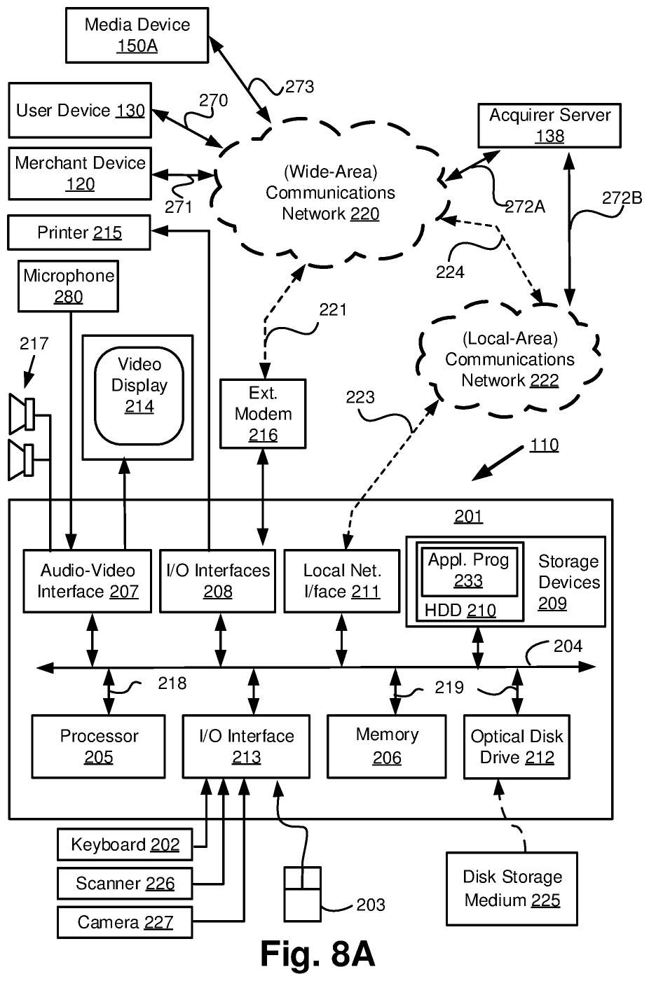

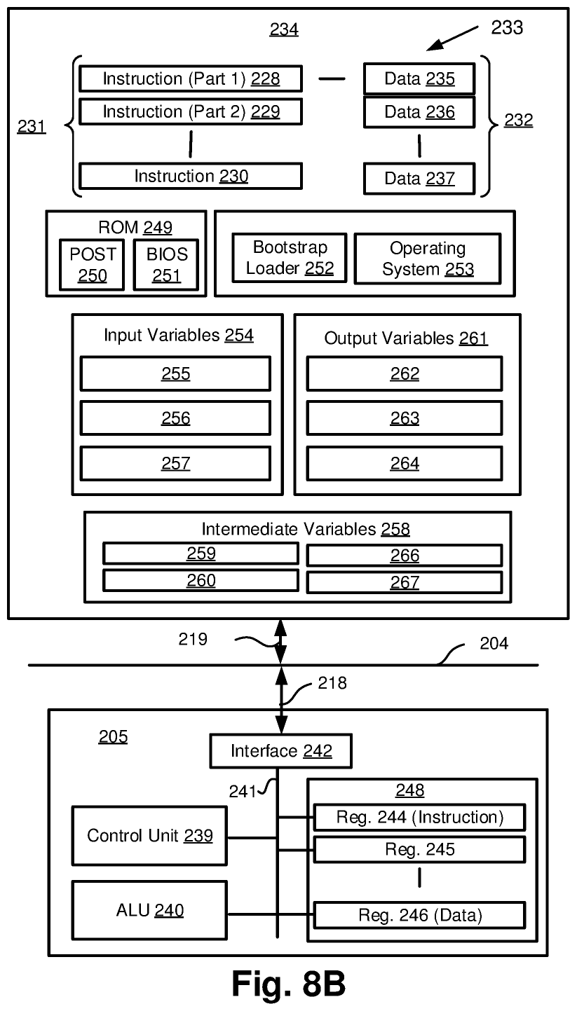

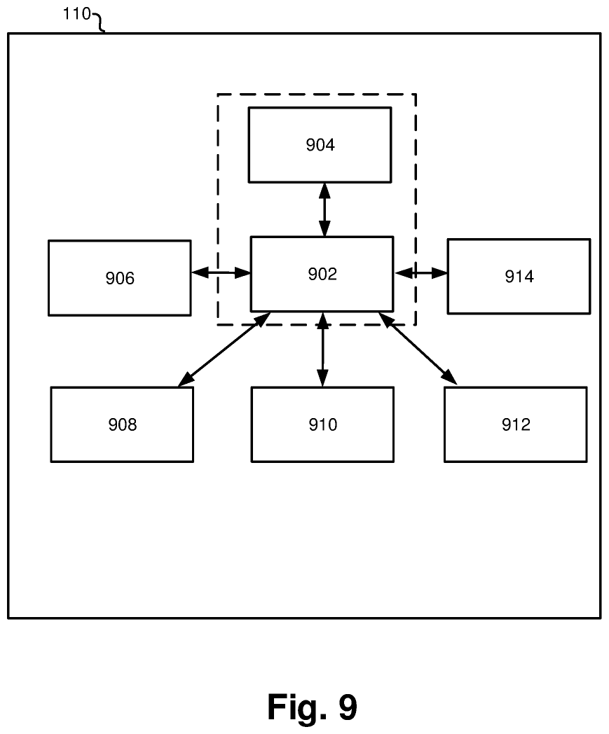

The present disclosure commences by discussing a system 100 (see FIG. 1) in which the online payment system is implemented. The role of each of the devices and servers in the system 100 is first discussed. The present disclosure will then discuss the operation of a transaction portal server 110 in the system 100 (see FIGS. 2 to 5, 6A to 6D, and 7). The discussion will then turn to the structural context of the transaction portal server 110 (see FIGS. 8A and 8B, and 9).

FIG. 1 shows an online payment system 100 comprising a transaction portal server 110, merchant devices 120A to 120N, user devices 130A to 130N, media devices 150A to 150N, an acquirer server 138, a payment network server 140, and an issuer server 142.

The transaction portal server 110 is a server that hosts software application programs 233 (see FIGS. 8A and 8B) to function as an online payment system. The structural context of the transaction portal server 110 is discussed below in relation to FIGS. 8A and 8B.

In the illustrative embodiment, the transaction portal server 110 provides an interface to enable communication with each of the devices 120, 130, 150 and the server 138. The transaction portal server 110 provides an application programming interface (“API”) to facilitate such communication. Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. Examples of APIs include the REST API, and the like.

The transaction portal server 110 is configured to receive and send commands and data from and to the user devices 130A to 130N and the merchant devices 120A to 120N.

The transaction portal server 110 is also configured to receive details of transaction records from the merchant devices 120A to 120N. The transaction portal server 110 then generates and broadcasts transaction records (and associated transaction identifiers) based on the received transaction record details. The transaction portal server 110, in turn, transmits the broadcast transaction records and/or transaction identifiers associated with the broadcast transaction records to the user devices 130A to 130N, when any one of the user devices 130A to 130N transmits a transaction pairing request to the transaction portal server 110.

In one arrangement, the online payment system implemented in the transaction portal server 110 is compatible with existing payment apps, digital wallets, payment gateways (such as Mastercard Payment Gateway Services), and the like. In another arrangement, the online payment system implemented in the transaction portal server 110 is an additional function on a payment app or digital wallet, such as Masterpass or Qkr!.

The transaction portal server 110 may be operated by any entity (e.g. a company or organization), which includes an acquirer, a payment network server provider, and the like. If the acquirer operates the transaction portal server 110, then the acquirer may integrate the acquirer server 138 with the transaction portal server 110. If the payment network server provider operates the transaction portal server 110, then the payment network server provider may integrate the payment network server 140 with the transaction portal server 110.

The merchant devices 120A to 120N are devices that are used by merchants who are registered with the transaction portal server 110. The merchants offer goods and/or services (or products). Examples of the merchant devices 120A to 120N are tablets, laptops, desktop computers, smartphones, point-of-sales terminals, and the like. In the present disclosure, the merchant devices 120A to 120N do not refer specifically to point-of-sales terminals. The merchant devices 120A to 120N respectively connect with the transaction portal server 110 via connections 271. The connections 271 may be wired or wireless connections. Hereinafter, the merchant devices 120A to 120N are collectively referred to as the merchant devices 120 (when referring to all of the merchant devices) and the merchant device 120 (when referring to a single merchant device). As described above, the merchant devices 120 can communicate with the transaction portal server 110. The merchant devices 120 can provide commands to the transaction portal server 110 in the form of voice, text, and the like.

The user devices 130A to 130N are devices that are used by consumers who are registered with the transaction portal server 110. The consumers are users who wish to buy goods or services from the merchant that offers goods or services (see the discussion on the merchant devices 120). Examples of the user devices 130A to 130N are tablets, laptops, desktop computers, smartphones, and the like. The user devices 130A to 130N respectively connect with the transaction portal server 110 via connections 270. The connections 270 may be wired or wireless connections. Hereinafter, the user devices 130A to 130N are collectively referred to as the user devices 130 (when referring to all of the user devices) and the user device 130 (when referring to a single user device). As described above, the user devices 130 can communicate with the transaction portal server 110. The user devices 130 can provide commands to the transaction portal server 110 in the form of voice, text, and the like.

The media devices 150A to 150N are devices that may be used by the merchant, which offers goods and services (see the discussion on the merchant device 120), to present transaction records or transaction identifiers associated with the transaction records. Examples of the media devices 150A to 150N are display screens, speakers, virtual reality devices, augmented reality devices, mixed media devices, and the like. The media devices 150A to 150N respectively connect with the transaction portal server 110 via connections 273. The connections 273 may be wired or wireless connections. Hereinafter, the media devices 150A to 150N are collectively referred to as the media device 150 (when referring to all of the media devices) and the media device 150 (when referring to a single media device).

In an alternative arrangement, the media devices 150 are connected to one of the merchant devices 120. Therefore, in the alternative arrangement, the transaction portal server 110 transmits the transaction records and/or the transaction identifiers associated with the broadcast transaction records to the merchant device 120, which in turn transmits the transaction records and/or the transaction identifiers associated with the broadcast transaction records to the media device 150 so that the transmitted transaction records and/or the transaction identifiers are presented at the media devices 150.

The transaction portal server 110 is in communication with the acquirer server 138. The acquirer server 138, in turn, is in communication with the payment network server 140. The payment network server 140, in turn, is in communication with the issuer server 142.

The acquirer server 138 generally is associated with an acquirer who may be an entity (e.g. a company or organization) which issues (e.g. establishes, manages, administers) a payment account (e.g. a financial bank payment account) of the merchant. Examples of the acquirer include a bank and/or other financial institution. The acquirer server 138 may include one or more computing devices that are used to establish communication with another server by exchanging messages with and/or passing information to the other servers 110 and 140.

The payment network server 140 is a server that hosts software application programs for processing payment of a transaction request message (which is associated with a broadcast transaction record) using a payment method specified by the user device 130. The payment network server 140 is one that is used to process transactions. As would be understood, the payment network server 140 communicates with a token vault (if required), and any other servers (e.g., an issuer server) to facilitate payment of transaction request messages (associated with broadcast transaction records) generated by the transaction portal server 110.

The issuer server 142 generally is associated with an issuer and may include one or more computing devices that are used to perform a payment transaction. The issuer may be an entity (e.g. a company or organization) which issues (e.g. establishes, manages, administers) a payment account (e.g. a financial bank payment account) of a user.

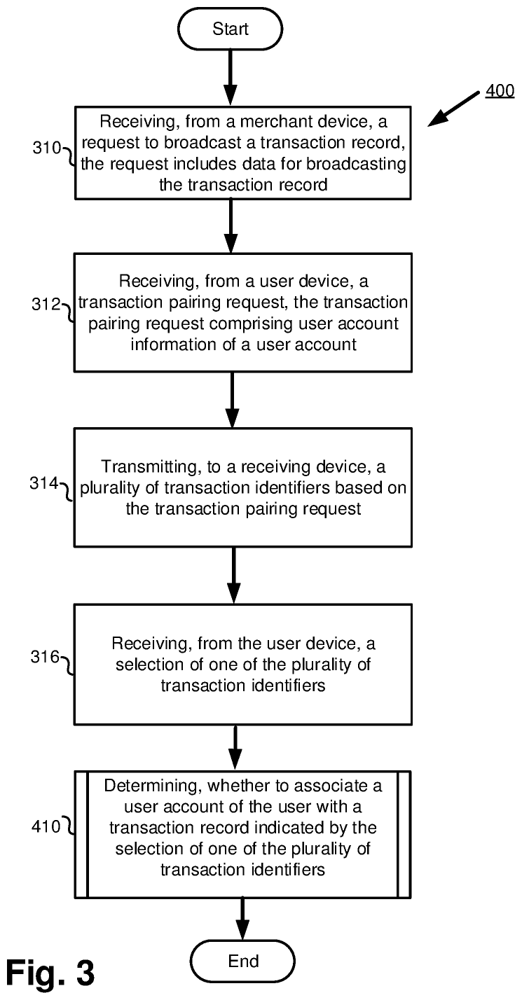

The transaction portal server 110 of the system 100 can replace a physical payment terminal (e.g., a point-of-sale terminal). Therefore, instead of a consumer interacting with a physical payment terminal, the consumers through their user devices 130 can interact with the transaction portal server 110 to pay for goods and services. The operation of the transaction portal server 110 will be discussed in more detail in relation to FIGS. 3 to 6, 7A and 7B, and 8A and 8B.

### Operations of the Transaction Portal Server 110

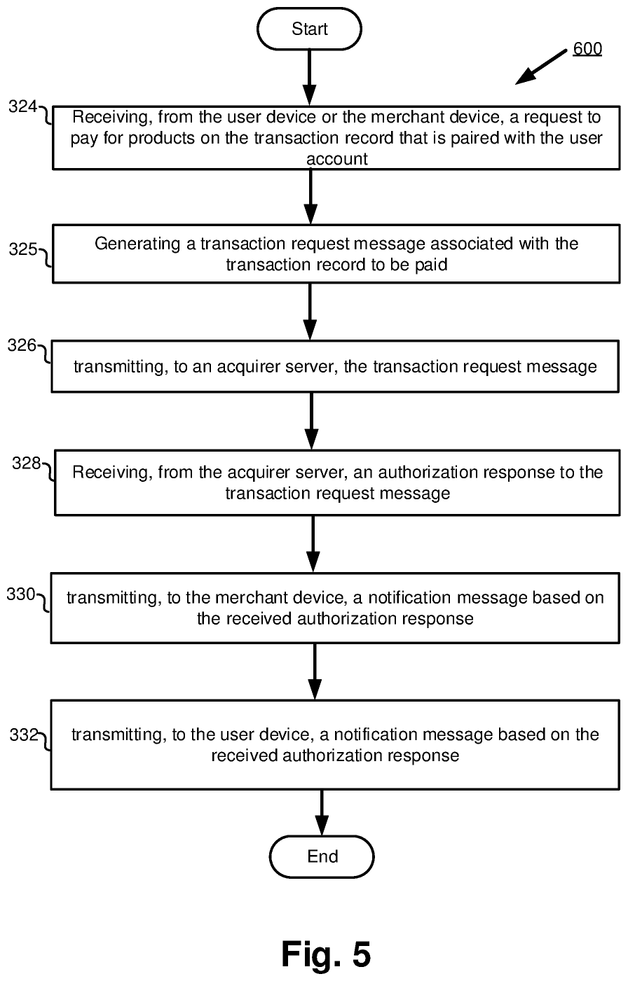

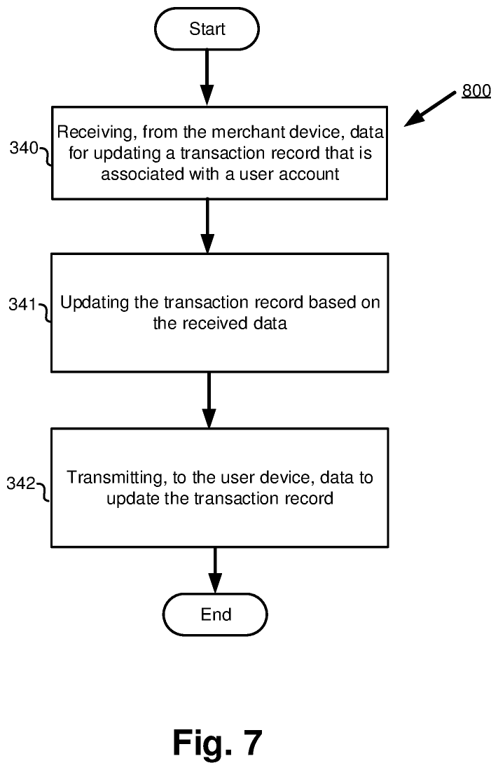

FIG. 2 is a flow chart diagram of data flow 300 of the system 100 when performing operations of the transaction portal server 110. The operations include (a) on-boarding of users and merchants to the online payment system hosted on the transaction portal server 110; (b) managing an association between a user account (created at on-boarding of a user) and a broadcast transaction record (see FIG. 3); (c) updating a transaction record that is associated with a user account (see FIG. 7); and (d) initiating payment of a transaction record that is associated with a user account (see FIG. 5).

### On-Boarding of Users and Merchants

Before a user or a merchant can use the transaction portal server 110, the user or the merchant must register with the transaction portal server 110. The registration step is called on-boarding. As shown respectively by the arrow 302 and 304, the merchant device 120 and the user device 130 separately perform on-boarding to the transaction portal server 110.

The on-boarding process for a user is performed by the user through one of the user devices 130. In one arrangement, the user downloads an app of the online payment system to the user device 130. In another arrangement, the user accesses a website of the online payment system on the user device 130. As described below in relation to FIGS. 8A and 8B, the API is part of the software application program 233. Once the user accesses the app or website on the user device 130, the user is able to interact with the transaction portal server 110 to register. The on-boarding process for a merchant is similarly performed.

A merchant on-boards the merchant by registering with the transaction portal server 110 through an app, a website, and the like of the online payment system on the merchant device 120. For ease of discussion, a user (e.g., a CEO, a CFO, a CTO, a company secretary, or any authorized person) relating to the merchant is referred to simply as a merchant. A merchant uses a merchant device 120 to register with the transaction portal server 110. Details of the registration include, for example, name of the merchant, merchant type, payment server to use, merchant payment account, merchant devices 120 that are authorized to send data for broadcasting transaction records, merchant locations, devices to which broadcast transaction records can be sent, type of payment, type of user payment accounts that the merchant would like to pair with, and the like. The details of the registration include any other data required by the acquirer associated with the merchant.

In one arrangement, the merchant may set up rules regarding devices to receive broadcast transaction records and/or transaction identifiers associated with the broadcast transaction records. For example, the receiving devices could be either the user devices 130 that transmit a transaction pairing request (i.e., a request to associate the broadcast transaction records and/or transaction identifiers of the broadcast transaction records with a user account) or the media devices 150 that the merchant has assigned to present the broadcast transaction records and/or the associated transaction identifiers. In certain circumstances, the merchant may restrict the presentation of the broadcast transaction records and/or the associated transaction identifiers to certain devices for security purposes.

In yet another arrangement, the merchant may set up rules on pre-determined approval criteria for an associated between a user account and a transaction record. For example, the merchant may pre-approved all transaction pairing requests if the total amount of a transaction record is below $50.

Once on-boarded, the merchant would have a merchant account that stores all the registration details and rules regarding the transaction records. Authorized merchant devices 120 are capable of sending data to broadcast transaction records and/or the transaction identifiers associated with the broadcast transaction records via the transaction portal server 110 and, if applicable, initiating payment of the broadcast transaction records that are associated with particular user accounts.

A user (i.e., a consumer) on-boards, via the user device 130, by registering with the transaction portal server 110 through an app, a website, and the like of the transaction portal server 110. A user uses a user device 130 to register with the transaction portal server 110. Details of the registration include, for example, name of the user, user payment account, user devices 130 that are authorized to request pairing of the user account with broadcast transaction records, pre-approved maximum transaction amount that the user has set, allowed payment scheme that the user has set, and the like. Once on-boarded, the transaction portal server 110 creates a user account for the user. In one arrangement, it may be possible for a user to create multiple user accounts on the transaction portal server 110. Authorized user devices 130 are then capable of transmitting a transaction pairing request of the user account with broadcast transaction records via the transaction portal server 110.

In one alternative arrangement, a user can use an existing user account, which is issued by an issuer (e.g., a bank, a financial institution, etc.) or an entity (e.g., Mastercard®, etc.), to use the transaction portal server 110. In this alternative arrangement, the transaction portal server 110 can connect into the core user management system of the issuer to enable the user to utilise the transaction portal server 110. Further, in this alternative arrangement, the user can use a Secure Remote Commerce (SRC) compatible app such as Masterpass® to access the transaction portal server 110.

Pre-approved maximum transaction amount relates to an amount that the user pre-approves. For example, if a transaction amount is below a pre-approved maximum transaction amount of $50, then a transaction on the transaction portal server 110 that involves a transaction amount of $50 or less does not require the user to approve after pairing with the transaction record (pairing with a transaction record is discussed below).

Allowed payment scheme includes details relating to payment installments for a bar tab type of payment.

In one arrangement, a user token is generated upon creation of the user account so that the details of the user payment account are not stored on the transaction portal server 110. The generation of the user token is performed by the transaction portal server 110 in conjunction with a token vault (not shown). The token vault may be operated by a third party or an institution (e.g., a bank) to which the user payment method is related.

### Managing Association Between a User Account and Broadcast Transaction Records

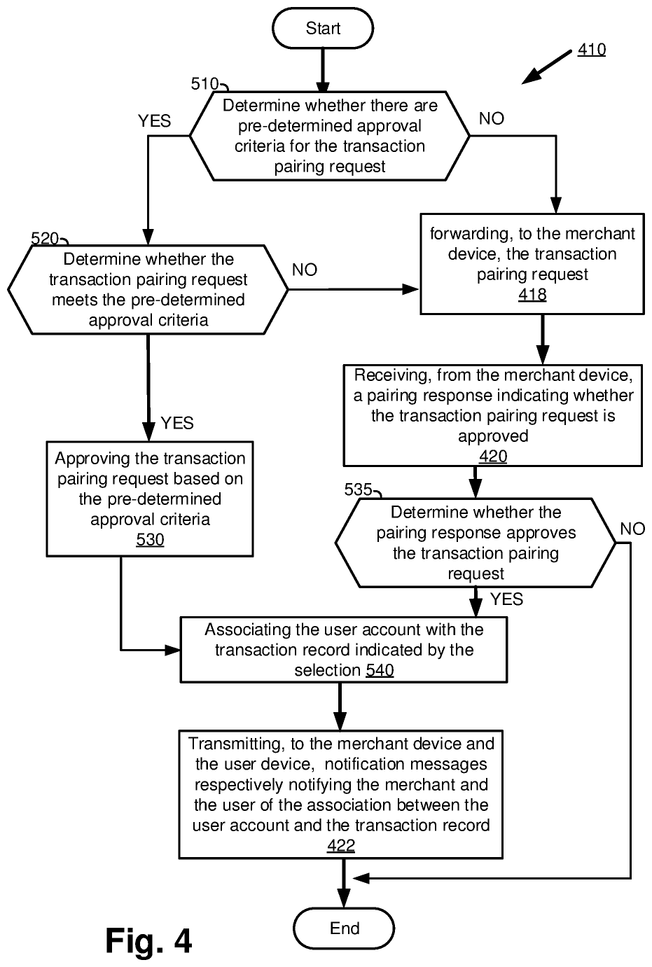

The discussion now turns to a method of processing a broadcast transaction record including associating the broadcast transaction record with a user account. An association between a user account of a user and a broadcast transaction record relates to an indication that the user would like to pay for the items listed in the broadcast transaction record using the user account. The advantages of such an association is the capability of providing the online payment system (as hosted by the transaction portal server 110), which provides a registered user with the capability of paying for items listed in a transaction record with different type of payments (e.g., installment payment, lump sum payment, etc.) at a plurality of registered merchants. Such processing is performed by the method 400 shown in FIGS. 4 and 5, and the attendant data flow shown in FIG. 2.

FIG. 3 shows a flow chart diagram of the method 400 of associating a user account with a broadcast transaction record. The method 400 is a software application program 233 (which contains the online payment system) that is executable by the processor 205 of the transaction portal server 110.

The method 400 commences at step 310 by receiving, from a merchant device 120, a request to broadcast a transaction record, the request includes data for broadcasting a transaction record. In an alternative arrangement, the data corresponds to a user-initiated transaction request for a purchase for goods and/or services (or products). The data includes, for example, the products that a user wants to purchase and a corresponding payable amount (or amount) of each product, the total payable amount (and the transaction currency code) of the transaction record, time information of the user-initiated transaction request, expiry time and date of the transaction record, location information of at least one of the products to be purchased, the user device 130 initiating the transaction request and the merchant device 120 sending the request to broadcast the transaction record, the type of payment, a transaction identifier, the location information at which the broadcast transaction record is to be located, and the like. The transaction identifier identifies a user and may be a name, a code, and the like. In one arrangement, the transaction identifier is provided by a user to the merchant.

The location information may be associated with GPS coordinates, Bluetooth beacon identifier, and the like of the user device 130, the merchant device 120, or the media device 150.

In an arrangement, the data corresponds to accompanying information (location, time, date, and amount) of a product (e.g., a theatre ticket) that the merchant offers. The product may not have been selected for purchase by a user. In other words, the information indicated in a transaction record may not correspond to a product that a user would like to purchase.

Such data are transmitted by the merchant device 120 to the transaction portal server 110. To transmit data of a transaction record from the merchant device 120, the merchant logs into the merchant account using the merchant device 120. The merchant then enters the required data for a transaction record on the merchant device 120. Once the data are entered, the merchant initiated the transfer of data from the merchant device 120 to the transaction portal server 110. The data flow of this step is shown in FIG. 2 with the same reference numeral 310. The data transfer can be initiated, for example, by pressing a button on the merchant device 120.

In the alternative arrangement discussed above, the user initiated the transaction request for a purchase of products. In such a case, the user may enter the required data for the transaction record that is received by the transaction portal server 110 at step 310. One example arrangement for this case is the user enters the data for a transaction record on the user device 130, which is then sent to a merchant device 120. The merchant then uses the merchant device 120 to approve the entered data and send the data to the transaction portal server 110.

In one arrangement, the merchant is able to set the type of payment for a transaction record. For example, the payment type could be that the transaction record must be paid in full. In another example, the payment type could be installment payment at pre-determined intervals at a pre-determined minimum amount for each installment.

In another arrangement, the merchant is able to send accompanying information (e.g., seating arrangements, venue, direction to the venue, etc.) to be displayed with the broadcast transaction record.

In yet another arrangement, the merchant device 120 also displays a transaction record, the data of which is sent by the merchant device 120 to the transaction portal server 110 in step 310.

Once the transaction portal server 110 receives the data of the transaction record to be broadcast, the method 400 then proceeds from step 310 to step 312.

In step 312, the transaction portal server 110 receives, from a user device 130, a transaction pairing request, the transaction pairing request comprising user account information of a user account. The transaction pairing request indicates that the user would like to be responsible for payment of products listed in a transaction record by associating the transaction record with a user account indicated in the transaction pairing request.

In one arrangement, the transaction pairing request includes one or more filter parameters to filter transaction records and/or transaction identifiers associated with the broadcast transaction records that are presented to a receiving device at step 314 (discussed below). The one or more filter parameters include location information, details (e.g., name, company number, etc.) of the merchant, the total amount of the transaction record, time information relating to the transaction record, and the like. The time information could be used to filter the transaction records to retrieve broadcast transaction records that are generated within, for example, the last 10 minutes.

The location information may be location information of the merchant device 120 that is used to send the request to broadcast the transaction record. The location information may also be location information of the user device 130 that is used to send the request in step 312.

In relation to step 312, a user, using the user device 130, opens an app or website of the online payment system (which is hosted on the transaction portal server 110) on the user device 130. The user then logs into a user account of the online payment system. As described hereinbefore, in one alternative arrangement, a user may use an SRC compatible app such as Masterpass® to access the online payment system. Once logged into the user account, the user can transmit a transaction pairing request to the transaction portal server 110 where the transaction pairing request includes user account information of the user account.

As discussed above, the transaction pairing request may include filter parameters such as location information, merchant details, and the like. For example, the user may enter location information relating to a broadcast transaction record that the user wants the user account to be associated with. The user then submits the transaction pairing request (and filter parameters, if applicable) to the transaction portal server 110. The data flow of the step 312 is shown in FIG. 2.

As discussed, one of the filter parameters is location information. The location information can be, for example, the location of the user device 130 from which the request is sent, a location selected by the user on the user device 130, a merchant's name, and the like.

In one example, a user device 130 at Darling Harbour, Sydney transmits a transaction pairing request with a filter parameter of location identifying Darling Harbour, Sydney. To do so, the user uses the GPS location of the user device 130 as the location information and sends the transaction pairing request with the location information to the transaction portal server 110 in order to effectively request broadcast transaction records and/or the transaction identifiers associated with the broadcast transaction records around Darling Harbour, Sydney. In another example, the user manually enters the location information as Darling Harbour, Sydney and then sends the transaction pairing request with the manually entered location information.

In another example, a user device 130 at Darling Harbour, Sydney wants broadcast transaction records in Changi Airport, Singapore because the user of that user device 130 wants to pay for his friend's meals. Therefore, the user sends a transaction pairing request with a filter parameter of location information around Changi Airport, Singapore on the app or website of the online payment system on the user device 130.

To further filter the request, the user may enter other filter parameters into the user device 130. The other filter parameters may be the name of the restaurant that the friend is dining at or the transaction identifier to identify the transaction record to pay.

The transaction portal server 110, upon receiving the transaction pairing request from the user device 130, processes the transaction pairing request and determines from the database (stored in the memory 206 of the transaction portal server 110) broadcast transaction records and/or transaction identifiers associated with the broadcast transaction records that are relevant to the transaction pairing request.

In one arrangement, the transaction pairing request must have one filter parameter to limit the number of transaction identifiers and/or transaction records being sent in step 314 (discussed below).

In an arrangement, the transaction pairing request includes a user identifier identifying the user. The user identifier may be obtained from the user account information included in the transaction pairing request. In another example, the user identifier may be manually entered by a user when transmitting the transaction pairing request. On the merchant account, there may be a list of trusted user identifiers, which includes user identifiers that the merchant has transacted with previously for a pre-determined number of times. In another arrangement, the merchant may have manually entered the list of trusted user identifiers. Therefore, when the merchant receives the transaction pairing request (see step 418 of sub-process 410 shown in FIG. 4, discussed below), the merchant is able to determine whether the pairing request is from a trusted user identifier. Alternatively, the pre-determined approval criteria (see step 520 of sub-process 410 shown in FIG. 4) may include the list of trusted user identifiers.

The method 400 then proceeds from step 312 to step 314.

In step 314, the transaction portal server 110 transmits, to a receiving device, transaction identifiers associated with the broadcast transaction records that are retrieved based on the transaction pairing request. In one arrangement, the broadcast transaction records are also transmitted in step 314.

If filter parameters are included in the transaction pairing request, the broadcast transaction records and/or the transaction identifiers would be filtered according the filter parameters. For example, if the transaction pairing request includes a filter parameter of location information, then the broadcast transaction records and/or the transaction identifiers associated with the broadcast transaction records transmitted to the receiving device would be filtered based on the location information. See the data flow of this step in FIG. 2 where the receiving device is a user device 130. The term “receiving device” refers to any one of the user devices 130 and the media devices 150. The transmission of the broadcast transaction records and/or the transaction identifiers associated with the broadcast transaction records of the merchant is in accordance with the rules in the merchant account.

In this step, the transaction portal server 110 transmits the broadcast transaction records and/or the transaction identifiers in a data format defined according to the API. For example, the transaction portal server 110 transmits the same data format to the media device 150, which is a speaker in this example. The media device 150 then converts the received data format of the transaction records and/or the transaction identifiers to audio so that the media device 150 can play back the audio transaction records and/or the transaction identifiers.

In one arrangement, the broadcast transaction records and/or the transaction identifiers associated with the broadcast transaction records are sent to the user device 130, which converts the data format from the transaction portal server 110 into a format that the user device 130 can present. In another arrangement, the broadcast transaction records and/or transaction identifiers are sent to the media device 150. Once the transaction records and/or transaction identifiers have been transmitted to the receiving device (i.e., either the user device 130 or the media device 150), the method 400 proceeds from step 314 to step 316.

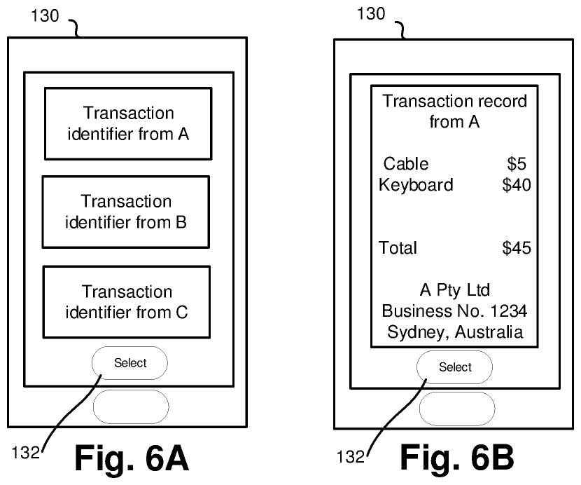

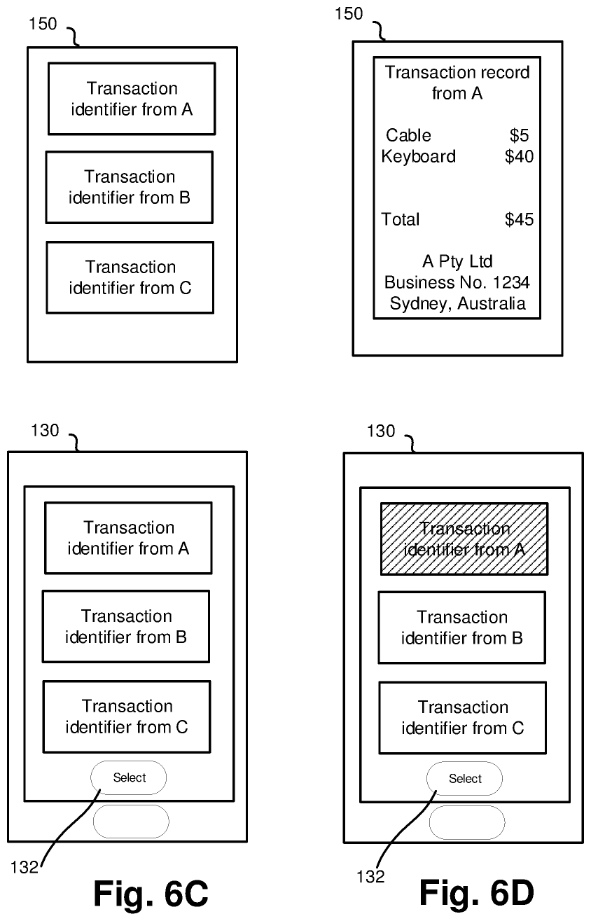

There is an intermediate step (not shown in the figures) that is taken by the user device 130 to select one of the transmitted broadcast transaction records and/or transaction identifiers after step 314. In one arrangement, when the broadcast transaction records are sent to the user device 130, the user device 130 displays the broadcast transaction records and/or transaction identifiers associated with the broadcast transaction records. One example of this display is shown in FIG. 6A, which shows a user device 130 (in this case, a mobile telephone with a touch screen interface) displaying the transaction identifiers associated with broadcast transaction records. The user then selects one of the transaction identifiers and the display on the user device 130 presents the transaction record of the selected transaction identifier (as shown in FIG. 6B). In other words, upon selection of the transaction identifier, the details of the transaction record are displayed for the user to review. As would be appreciated by a person skilled in the art, the user device 130 may communicate with the transaction portal server 110 to retrieve the transaction record of the selected transaction identifier.

When the user determines that the displayed transaction identifier or transaction record is the one to be selected, the user presses the select button 132 to submit the selection. The user device 130 then transmits to the transaction portal server 110 the selection of the transaction identifier or the transaction record so that a pairing between the user account relating to the user and the selected transaction record can occur.

In another arrangement of the intermediate step, the broadcast transaction records and/or transaction identifiers associated with the broadcast transaction records are sent to the media device 150 (optionally via the merchant device 120). The media device 150 displays the broadcast transaction records and/or transaction identifiers associated with the broadcast transaction records. FIG. 6C shows transaction identifiers being shown on the media device 150. At the same time, the user device 130 displays a screen to select one of the transaction identifiers displayed on the media device 150 (see FIG. 6C). Once a transaction identifier is selected on the user device 130 (see the greying out of “Transaction identifier from A” in FIG. 6D), the media device 150 displays the transaction record of the selected transaction identifier (shown in FIG. 6D). The user can then press the select button 132 to select the transaction identifier from A. Once the selection is made, the user device 130 transmits to the transaction portal server 110 the selected transaction identifier so that the user account relating to the user can be associated with a broadcast transaction record of the selected transaction identifier.

In one arrangement, there may be more than one payment account associated with the user. Once the user selects the transaction identifier and/or transaction record, the user may then select one of the payment accounts to use.

Referring back to method 400, the next step is step 316. In step 316, the transaction portal server 110 receives, from the user device 130, the selection of one of the transaction identifiers transmitted in step 314. See the data flow of step 316 in FIG. 2. As discussed above, the transaction records may also be transmitted in step 314 and subsequently selected in the intermediate step. In such a case, the selected transaction record is received by the transaction portal server 110.

The method 400 proceeds from step 316 to sub-process 410.

In sub-process 410, the method 400 determines whether to associate the user account indicated in the transaction pairing request with the transaction record indicated by the selection of one of the transaction identifiers. As discussed above, in one arrangement, the transaction portal server 110 receives a selected transaction record. In such a case, the method 400 determines whether to associate the user account indicated in the transaction pairing request with the selected transaction record. Sub-process 410 is shown in FIG. 4. The data flow of some of the steps in sub-process 410 are shown in FIG. 2.

Sub-process 410 commences at step 510 where it is determined whether there are pre-determined approval criteria for a transaction pairing request. As described above in relation to the on-boarding process, the merchant may set up pre-determined approval criteria for associating a user account with a transaction record. If YES, sub-process 410 proceeds from step 510 to step 520. If NO, sub-process 410 proceeds from step 510 to step 418.

In step 520, sub-process 410 determines whether the transaction pairing request meets the pre-determined approval criteria. For example, as described above in relation to step 312, the pre-determined approval criteria may include a list of trusted user identifiers. In such a case, a transaction pairing request from a user identifier in the list of trusted identifiers is approved and the transaction pairing request is determined by the server 110 to meet the pre-determined approval criteria. If NO, sub-process 410 proceeds from step 520 to step 418. If YES, sub-process 410 proceeds from step 520 to step 530.

In step 530, sub-process 410 approves the transaction pairing request based on the pre-determined approval criteria. Sub-process 410 proceeds from step 530 to step 540.

Before describing step 540, the discussion turns back to step 418. In step 418, sub-process 410 forwards, to the merchant device 120, the transaction pairing request. See the data flow of step 418 in FIG. 2. Sub-process 410 then proceeds from step 418 to step 420.

In the intermediate step not shown in FIG. 4, the merchant reviews the transaction pairing request and the selected transaction record on the merchant device 130 and approves the transaction pairing request if the transaction pairing request is acceptable to the merchant. Otherwise, the merchant rejects the transaction pairing request. The merchant then sends a pairing response indicating whether the transaction pairing request is approved using the merchant device 130.

The transaction portal server 110 then receives the pairing response in step 420. As shown in FIG. 5, in step 420, the transaction portal server 110 receives, from the merchant device 130, the pairing response indicating approval or rejection of the transaction pairing request. The data flow of step 420 is shown in FIG. 2. Sub-process 410 proceeds from step 420 to 535.

In step 535, sub-process 410 determines whether the pairing response approves or rejects the transaction pairing request. If NO, sub-process 410 concludes and a notification message is sent to the user device 130 notifying the user of the rejection of the transaction pairing request. If YES, sub-process 410 proceeds from step 535 to step 540.

In step 540, sub-process 410 associates the user account indicated in the transaction pairing request with the transaction record indicated by the selection of one of the transaction identifiers in step 316. As discussed above, in one arrangement, sub-process 410 associates the user account indicated in the transaction pairing request with the transaction record selected in step 316. Sub-process 410 then proceeds from step 540 to step 422.

In step 422, sub-process 410 triggers the transaction portal server 110 to transmit, to the merchant device 120 or the user device 130, notification messages respectively notifying the merchant or the user respectively of whether the user account indicated in the transaction pairing request is determined to be associated with the transaction record indicated by the selection of one of the transaction identifiers in step 316. The data flow of step 422 is shown in FIG. 2. The notification messages sent to the merchant device 120 or the user device 130 may be sent out of band. That is, the notification messages can be sent via, for example, an SMS text, an email, and the like to a user device 120 that does not send the transaction pairing request at step 316. Sub-process 410 concludes at the conclusion of step 422.

Referring back to FIG. 2, the next step is a method 800 of updating a transaction record that is associated with a user account. The method 800 is shown in FIG. 7. The method 800 commences at step 340 where the transaction portal server 110 receives, from the merchant device 120, data for updating a transaction record that is associated with a user account. The data flow of step 340 is shown in FIG. 2.

In one arrangement, the user after associating a user account with a transaction record may decide to purchase an additional product. In such a case, the merchant can send additional data for updating the transaction record associated with the user account to include a further product and an amount corresponding to the further product.

The method 800 proceeds from step 340 to step 341.

In step 341, the transaction portal server 110 updates the transaction record with the data received at step 340. The method 800 then proceeds from step 341 to step 342.

In step 342, the Transaction portal server 110 transmits, to the user device 130, data to update the transaction record presented on the user device 130. The data flow for step 342 is shown in FIG. 2. The method 800 concludes after transmitting the update data.

Referring back to FIG. 2, the next step is a method 600 of paying for the items listed on the transaction record. The method 600 is shown in a flow chart diagram in FIG. 5. The method 600 describes initiating a payment to transfer a fund relating to an amount for a product indicated in the transaction record in response to receiving a payment request.

The method 600 commences at step 324 where the transaction portal server 110 receives, from the user device 130, a request to pay for items on the transaction record that is paired with the user account of the user device 130. The data flow of step 324 is shown in FIG. 2.

In one arrangement, as described in step 310 above, the payment type can be installment payment where the user can pay for items on the transaction record in installments at a pre-determined minimum amount. If this is the type of payment, then the user must set a pre-determined amount (which is at the minimum pre-determined amount or higher) to pay the installments. In another arrangement, as also described in step 310 above, the payment type is a lump sum payment to pay for the total amount of the transaction record.

The method 600 proceeds from step 324 to step 325.

In step 325, the transaction portal server 140 generates a transaction request message associated with the transaction record to be paid. The transaction request message is also generated based on the payment type.

For example, if the payment type is an installment payment with a pre-determined minimum amount at a pre-determined interval, then a transaction request message is generated at a time that corresponds with the pre-determined interval. The transaction request message also has an amount in accordance with the pre-determined minimum amount.

In another example, if the payment type is a lump sum payment, then a transaction request message is generated with the total amount of the transaction record.

The method 600 proceeds from step 325 to step 326.

In step 326, the transaction portal server 110 transmits, to the acquirer server 138, the transaction request message (which is generated at step 325). In one arrangement, the request in step 326 can be initiated by either the user device 130 or the merchant device 120. In another arrangement, the transaction portal server 100 is pre-programmed to perform step 326 at a pre-determined time. In yet another arrangement, step 326 is performed in a batch processing so that multiple transaction request messages (associated with multiple transaction records) are requested to be paid at the same time. In yet another arrangement, step 326 is performed multiple times at pre-determined intervals to reduce the balance of the transaction record, which is performed for an installment type payment. In yet another arrangement, step 326 is performed by the server 110 in accordance with rules set up in the merchant account.

In one arrangement, the request includes a payment token that has been generated by the transaction portal server 110 based on the user token of the user account and the transaction record. Therefore, the payment token is sent to the acquirer server 138. The payment token, in one arrangement, is generated according to the EMVco standard for tokenization.

The acquirer server 138, in turn, sends the transaction request message to the payment network server 140. The payment network server 140, in turn, sends the transaction request message to the issuer server 142. The issuer server 142 then provides an authorization response (e.g., authorizing or declining the transaction request message) to the payment network 140, which is provided back through the acquirer server 138.

The data flow of step 326 between the transaction portal server 110 and the acquirer server 138 is shown in FIG. 2. The data flow between the acquirer server 138, the payment network server 140, and the issuer server 142 is not shown for simplicity sake.

In one arrangement, the acquirer operates the transaction portal server 110 and integrate the acquirer server 138 with the transaction portal server 110. In this arrangement, the integrated acquirer server 138 and the transaction portal server 110 transmits the transaction request message (which is generated at step 325) to the payment network server 140. The payment network server 140, in turn, sends the transaction request message to the issuer server 142. The issuer server 142 then provides an authorization response (e.g., authorizing or declining the transaction request message) to the payment network 140, which is provided back through the integrated acquirer server 138 and transaction portal server 110.

In one arrangement, the payment network server provider operates the transaction portal server 110 and integrate the payment network server 140 with the transaction portal server 110. In this arrangement, the integrated payment network server 140 and the transaction portal server 110 transmits the transaction request message (which is generated at step 325) to the acquirer server 138. The acquirer server 138 then transmits the transaction request message to the integrated payment network server 140 and the transaction portal server 110. The integrated payment network server 140 and the transaction portal server 110, in turn, sends the transaction request message to the issuer server 142. The issuer server 142 then provides an authorization response (e.g., authorizing or declining the transaction request message) to the integrated payment network 140 and transaction portal server 110, which is provided back through the acquirer server 138.

The method 600 proceeds from step 326 to step 328.

In step 328, the transaction portal server 110 receives, from the acquirer server 138, the authorization response to the transaction request message in step 326. The authorization response indicates whether the transaction request message is approved or rejected. The data flow of step 328 is shown in FIG. 2. The method 600 proceeds from step 328 to step 330.

In step 330, the transaction portal server 110 transmits, to the merchant device 120, a notification message based on the received authorization response. For example, the notification message includes an approval of the payment and therefore the approval message is sent to the merchant device 120. The data flow of step 330 is shown in FIG. 2. The method 600 proceeds from step 330 to step 332.

In step 332, the transaction portal server 110 transmits, to the user device 130, a notification message based on the received authorization response. For example, the notification message includes an approval of the payment and therefore the approval message is sent to the user device 130. The data flow of step 332 is shown in FIG. 2. The method 600 concludes at the conclusion of step 332.

### Use Case Examples

Some examples of use case of the system 100 will now be described. These examples are illustrative and not restrictive.

### First Use Case of the System 100

In the first use case, let the merchant be a company having restaurants called YY's Yummy Restaurants in Australia and Singapore.

A merchant can on-board the merchant to the transaction portal server 110 via a merchant device 120. The merchant device 120, as described above, can be a desktop computer, a laptop, a smartphone, a tablet, and the like. If the merchant uses a desktop computer or a laptop, then the merchant may access the transaction portal server 110 via a website of the transaction portal server 110. On the other hand, if the merchant uses a tablet or a smartphone, the merchant can access the website, or download and install an app of the transaction portal server 110 to access the transaction portal server 110 via the installed app.

The merchant then uses the relevant app or website to register the merchant with the transaction portal server 110. During registration, the merchant enters the locations of each restaurant that is authorized to use the online payment system.

A user can on-board to the transaction portal server 110 via a user device 130. The user device 130, as described above, can be a desktop computer, a laptop, a smartphone, a tablet, and the like. If the user uses a desktop computer or a laptop, then the user may access the transaction portal server 110 via a website of the transaction portal server 110. On the other hand, if the user uses a tablet or a smartphone, the user can access the website, or download an app of the transaction portal server 110 and access the transaction portal server 110 via the downloaded app.

In this example, the user goes to YY's Yummy Restaurant at Darling Harbour, Sydney, which has been authorized by the merchant to use the online payment system. The user orders $100 worth of food and wants to pay for the food. The user accesses an app or website of the online payment system and logs into a user account relating to the user. The user then transmits (step 312 of the method 400) a transaction pairing request. In this case, the user also enters a filter parameter of location information of Darling Harbour, Sydney to filter for broadcast transaction records at the location of Darling Harbour, Sydney. In one alternative arrangement, the user also enters a filter parameter of the restaurant's name of YY's Yummy Restaurant into the app or website of the online payment system. The filter parameter of the restaurant's name would further filter the broadcast transaction records.

If no transaction record relating to the user's purchase of food is available, then the user can select a request for a transaction record and the server 110 in turn sends a notification message (an optional step that is not shown in the method 400) to the merchant device 120 for data relating to the transaction record. If there is a broadcast transaction record, then the user can select on the user device 130 one of the transaction records broadcast by the server 110.

To broadcast the transaction record, the staff member of the restaurant accesses, using the merchant device 120, the app or website of the transaction portal server 110 and enters (step 310 of the method 400) the details of the transaction record for that user.

When receiving the transaction pairing request from the user device 130, the transaction portal server 110 processes the transaction pairing request to retrieve transaction records that are broadcast in the location of Darling Harbour, Sydney. When the further filter parameter of restaurant's name is entered, the transaction portal server 110 further filters the transaction records so only transaction records relating to YY's Yummy Restaurants are retrieved.

Once the broadcast transaction records are retrieved based on the location information, the transaction portal server 110 transmits (step 314 of the method 400) the transaction identifiers of the retrieved transaction records (and/or the retrieved transaction records) to a receiving device (i.e., either the user device 130 or a media device 150). In this example, the transaction identifiers of the broadcast transaction records are transmitted to and displayed by the user device 130 (see FIG. 6A).

The user then selects one of the transaction identifiers (see FIG. 6B) displayed on the user device 130. The selection triggers the user device 130 to transmit the selected transaction identifier to the transaction portal server 110 in order to associate the user account (which the user logged into when accessing the app or website of the transaction portal server 110) and the selected transaction identifier to the transaction portal server 110. The transaction portal server 110, in turn, receives (step 316 of the method 400) the selected transaction identifier.

The transaction portal server 110 then performs sub-process 410 to determine whether to approve the transaction pairing request for the selected transaction identifier. Once approved, the transaction portal server 110 transmits a notification message that the transaction pairing request has been approved.

The notification message may be in the form of enabling a pay button on the app of the online payment system on the user device 130 to be activated. The user presses the pay button to initiate payment of the transaction record.

The user can then press (see step 324 of sub-process 410) the activated pay button to request payment of the selected transaction record. On the transaction portal server 110, the server 110 receives (step 324) the request to pay the transaction record.

As described above, the transaction portal server 110 generates a transaction request message associated with the transaction record (step 325) and may initiate the remaining steps 326 to 332 immediately or at a pre-determined time.

The user therefore pays for the food by accessing the app or website of the transaction portal server 110, transmitting a transaction pairing request, receiving transaction identifiers based on the transmitted transaction pairing request, selecting a transaction identifier (or a transaction record) associated with the food, and requesting payment of the selected transaction record. The user can perform these steps without having to go to a physical point-of-sale terminal and take out a wallet and card/cash from the wallet.

### Second Use Case of the System 100

In the second use case, let the merchant be the same merchant as the first use case.

In this use case, a staff member of the restaurant broadcasts a transaction record for the user as soon as the user sits down at a table and before any food is ordered. The user can then transmit a transaction pairing request (312) and select the transaction identifier or the transaction record (step 316) before even ordering the food. Steps 314 and 316 and sub-process 410 are performed similar to the first use case to approve the transaction pairing request. Once the transaction pairing request is approved, the transaction record can be updated (steps 340 and 342 of the method 800) as the staff member enters the food being ordered by the user. The user can also see the food being ordered on the user device 130.

When the user finishes eating, the user can access the app or website of the transaction portal server 110 and requests payment of the transaction record by pressing the pay button (step 324).

### Third Use Case of the System 100

In the third use case, let the merchant be the same merchant as the first use case.

The user in the third use case is located in Singapore. The user is also a registered user of the transaction portal server 110. The user chats with a friend (who is the consumer of the second use case) who is going into YY's Yummy Restaurant in Darling Harbour, Sydney. The friend in Darling Harbour, Australia then asks the user based in Singapore to pay for his meal.

Similar to the second use case, a staff member of the restaurant sends (step 310) a request to broadcast a transaction record for the friend as soon as that friend sits down at a table and before any food is ordered. In this case, the friend asks the merchant to put a transaction identifier (e.g., a name, a code, etc.) on the transaction record to enable the user to identify the friend's transaction record. As described above, the merchant may enter the name of the friend on the transaction record.

The user then transmits a transaction pairing request (step 312 of the method 400) with filter parameters of location information of Darling Harbour, Sydney and YY's Yummy Restaurant, before the friend has even started ordering the food. Steps 314 and 316 and sub-process 410 are performed similar to the first use case to approve the pairing request. The user then receives and selects the transaction identifier relating to his friend's transaction record.

Once the transaction pairing request is approved, the transaction record can be updated (steps 340 and 342 of the method 800) as the staff member enters the food being ordered by the consumer. The user can also see the food being ordered on the user device 130. In the update process (steps 340 and 342), the merchant can mark the transaction record to be ready for payment, which in turn triggers the transaction portal server 110 to send a notification message notifying the user in Singapore that the paired transaction record is ready to be paid.

When the user sees that the paired transaction record is ready to be paid, the user can access the app or website of the transaction portal server 110 and requests payment of the transaction record by, for example, pressing a button (step 324) on the user device 130. In turn, the transaction portal server 110 receives the request (step 324) and generates a transaction request message associated with the transaction record (step 325). The transaction portal server 110 may initiate the remaining steps 326 to 332 immediately or at a pre-determined time.

### Fourth Use Case of the System 100

In the fourth use case, let the merchant be a bar called The Queen.

The on-boarding of the merchant and the consumer are as described in the first use case. When the consumer enters the bar, a staff member of the bar sends a request to broadcast a transaction record similar to the second use case. Similar to the second use case, the consumer pairs with the transaction record before ordering any drinks or food. However, in this use case, the user sends a request to pair his user account with an ongoing transaction record that is paid at pre-determined intervals (e.g., weekly). In other words, the ongoing transaction record will be updated with information corresponding to additional drinks or food that the user is going to order in this use example.

Once paired, the consumer requests (step 324) to pay the transaction record at a pre-determined amount (e.g., $50) weekly. Accordingly, the transaction portal server 110 generates a transaction request message associated with the transaction record at the pre-determined amount weekly (step 325) and transmits (step 326) the transaction request message accordingly.

### Fifth Use Case of the System 100

In the fifth use case, let the merchant be an owner of a company which owns a theatre called Symphony Of Xi. The theatre is hosting a musical by a performer called Song.

The merchant would like to sell tickets to the musical through the online payment system. As described above, to use the online payment system hosted by the transaction portal server 110, the merchant must be registered with the transaction portal server 110. The on-boarding of the merchant is as discussed in the first use case.

In this example, the merchant advertises the event by putting up advertisements at bus stops across Singapore. The merchant therefore sends (step 310) data for transaction records where the transaction records are placed at the locations of the bus stops. Many transaction records for different type of seats in the musical may be uploaded to the transaction portal server 110.

When a consumer sees the advertisement at one of the bus stops, the consumer may want to purchase a ticket to the event. In this case, the consumer accesses, using the user device 130, the app or website of the transaction portal server 110 and logs into a user account. Once logged in, the consumer transmits a transaction pairing request (step 312) with a filter parameter of location information of the location of the user device 130. The transaction records relating to the tickets are retrieved by the transaction portal server 110. Transaction identifiers associated with the retrieved transaction records are then transmitted (step 314) to the user device 130. The transaction record regarding the event (e.g., seating arrangements, performance times, etc.) may also be sent to accompany the transaction identifiers.

The user reviews the transaction records and the accompanying information, which are displayed on the user device 130. The user then selects one of the transaction identifiers (or transaction records) and the user device 130 sends the selection to the transaction portal server 110. The transaction portal server 110 in turn receives (step 316) the selection. The transaction portal server 110 performs sub-process 410 as described above and sends a notification message to the user device 130 of the result of the pairing request.

The notification message may be in the form of enabling a pay button on the app of the online payment system on the user device 130 to be activated. The consumer presses the pay button to initiate payment of the transaction record.

The user can then press (see step 324 of sub-process 410) the activated pay button to approve payment of the selected transaction record. On the transaction portal server 110, the server 110 receives (step 324) the request to pay the transaction record and generates (step 325) a transaction request message associated with the transaction record.

As described above, the transaction portal server 110 may initiate the remaining steps 326 to 332 immediately or at a pre-determined time.

### Structural Context of the Transaction Portal Server 110

FIGS. 8A and 8B depict the transaction portal server 110, upon which the online payment system described above can be practiced.

As seen in FIG. 8A, the transaction portal server 110 includes: a computer module 201; input devices such as a keyboard 202, a mouse pointer device 203, a scanner 226, a camera 227, and a microphone 280; and output devices including a printer 215, a display device 214 and loudspeakers 217. An external Modulator-Demodulator (Modem) transceiver device 216 may be used by the computer module 201 for communicating to and from a communications network 220 via a connection 221. The communications network 220 may be a wide-area network (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable) connection, the modem 216 may be a broadband modem. A wireless modem may also be used for wireless connection to the communications network 220.

The input and output devices may be used by an operator who is interacting with the transaction portal server 110. For example, the printer 215 may be used to print reports relating to the status of the transaction portal server 110.

The transaction portal server 110 uses the communications network 220 to communicate with the merchant devices 120 and the user devices 130 to receive commands and data. The transaction portal server 110 also uses the communications network 220 to communicate with the merchant devices 120, the user devices 130, and the media devices 150 to send notification messages or broadcast transaction records.

The computer module 201 typically includes at least one processor unit 205, and at least one memory unit 206. For example, the memory unit 206 may have semiconductor random access memory (RAM) and semiconductor read only memory (ROM). The computer module 201 also includes an number of input/output (I/O) interfaces including: an audio-video interface 207 that couples to the video display 214, loudspeakers 217 and microphone 280; an I/O interface 213 that couples to the keyboard 202, mouse 203, scanner 226, camera 227 and optionally a joystick or other human interface device (not illustrated); and an interface 208 for the external modem 216 and printer 215. In some implementations, the modem 216 may be incorporated within the computer module 201, for example within the interface 208. The computer module 201 also has a local network interface 211, which permits coupling of the computer system 110 via a connection 223 to a local-area communications network 222, known as a Local Area Network (LAN). As illustrated in FIG. 8A, the local communications network 222 may also couple to the wide network 220 via a connection 224, which would typically include a so-called “firewall” device or device of similar functionality. The local network interface 211 may comprise an Ethernet circuit card, a Bluetooth® wireless arrangement or an IEEE 802.11 wireless arrangement; however, numerous other types of interfaces may be practiced for the interface 211.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the transaction portal server 110.

The components 205 to 213 of the computer module 201 typically communicate via an interconnected bus 204 and in a manner that results in a conventional mode of operation of a computer system known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun Sparcstations, Apple Mac™ or like computer systems.

The methods of operating the transaction portal server 110, as shown in the processes of FIGS. 4, 5, 6, and 8 to be described, may be implemented as one or more software application programs 233 executable within the transaction portal server 110. In particular, the steps of the methods shown in FIGS. 4, 5, 6, and 8 are effected by instructions 231 (see FIG. 8B) in the software (i.e., computer program codes) 233 that are carried out within the transaction portal server 110. The software instructions 231 may be formed as one or more code modules, each for performing one or more particular tasks. The software may also be divided into two separate parts, in which a first part and the corresponding code modules performs the operation of the transaction portal server 110 and a second part and the corresponding code modules manages the API and corresponding user interfaces in the merchant devices 120, the user devices 130, and on the display 214. In other words, the second part of the software manages the interaction between (a) the first part and (b) any one of the merchant devices 120, the user devices 130, and the operator of the server 110.

The software may be stored in a computer readable medium, including the storage devices described below, for example. The software is loaded into the transaction portal server 110 from the computer readable medium, and then executed by the computer system 110. A computer readable medium having such software or computer program recorded on the computer readable medium is a computer program product. The use of the computer program product in the transaction portal server 110 preferably effects an advantageous apparatus for managing an association between a user account and a broadcast transaction record for functioning as an online payment system.

The software (i.e., computer program codes) 233 is typically stored in the HDD 210 or the memory 206. The software 233 is loaded into the computer system 110 from a computer readable medium (e.g., the memory 206), and executed by the processor 205. Thus, for example, the software 233 may be stored on an optically readable disk storage medium (e.g., CD-ROM) 225 that is read by the optical disk drive 212. A computer readable medium having such software or computer program recorded on it is a computer program product. The use of the computer program product in the server 110 preferably effects an apparatus for processing a broadcast transaction record, which includes associating a user account with broadcast transaction record, for functioning as an online payment system.

In some instances, the application programs 233 may be supplied to the user encoded on one or more CD-ROMs 225 and read via the corresponding drive 212, or alternatively may be read by the user from the networks 220 or 222. Still further, the software can also be loaded into the transaction portal server 110 from other computer readable media. Computer readable storage media refers to any non-transitory tangible storage medium that provides recorded instructions and/or data to the transaction portal server 110 for execution and/or processing by the processor 205. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of software, application programs, instructions and/or data to the computer module 201 include radio or infra-red transmission channels as well as a network connection to another computer or networked device, and the Internet or Intranets including e-mail transmissions and information recorded on Websites and the like.

The second part of the application programs 233 and the corresponding code modules mentioned above may be executed to implement one or more API of the transaction portal server 110 with associated graphical user interfaces (GUIs) to be rendered or otherwise represented upon the display 214 or the display of the merchant device 120 and the user device 130. Through manipulation of typically the keyboard 202 and the mouse 203, an operator of the server 110 and the application may manipulate the interface in a functionally adaptable manner to provide controlling commands and/or input to the applications associated with the GUI(s). Similarly, on the merchant devices 120 and the user devices 130, a user of those devices 120 and 130 manipulate the input devices (e.g., touch screen, keyboard, mouse, etc.) of those devices 120, 130 in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280. These other forms of functionally adaptable user interfaces may also be implemented on the merchant devices 120 and the user devices 130.

FIG. 8B is a detailed schematic block diagram of the processor 205 and a “memory” 234. The memory 234 represents a logical aggregation of all the memory modules (including the HDD 209 and semiconductor memory 206) that can be accessed by the computer module 201 in FIG. 8A.

When the computer module 201 is initially powered up, a power-on self-test (POST) program 250 executes. The POST program 250 is typically stored in a ROM 249 of the semiconductor memory 206 of FIG. 8A. A hardware device such as the ROM 249 storing software is sometimes referred to as firmware. The POST program 250 examines hardware within the computer module 201 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 8A. Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfil various high level functions, including processor management, memory management, device management, storage management, software application interface, and generic user interface.

The operating system 253 manages the memory 234 (209, 206) to ensure that each process or application running on the computer module 201 has sufficient memory in which to execute without colliding with memory allocated to another process. Furthermore, the different types of memory available in the server 110 of FIG. 8A must be used properly so that each process can run effectively. Accordingly, the aggregated memory 234 is not intended to illustrate how particular segments of memory are allocated (unless otherwise stated), but rather to provide a general view of the memory accessible by the server 110 and how such is used.

As shown in FIG. 8B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using a connection 218. The memory 234 is coupled to the bus 204 using a connection 219.

The application program 233 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 220, 202, data retrieved from one of the storage devices 206, 209 or data retrieved from a storage medium 225 inserted into the corresponding reader 212, all depicted in FIG. 8A. The execution of a set of the instructions may in some cases result in output of data. Execution may also involve storing data or variables to the memory 234.

The disclosed association management and payment initiation arrangements use input variables 254, which are stored in the memory 234 in corresponding memory locations 255, 256, 257. The association management and payment initiation arrangements produce output variables 261, which are stored in the memory 234 in corresponding memory locations 262, 263, 264. Intermediate variables 258 may be stored in memory locations 259, 260, 266 and 267.

Referring to the processor 205 of FIG. 8B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises:

a fetch operation, which fetches or reads an instruction 231 from a memory location 228, 229, 230;

a decode operation in which the control unit 239 determines which instruction has been fetched; and

an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

Each step or sub-process in the processes of FIGS. 3, 4, 5, and 7 is associated with one or more segments of the program 233 and is performed by the register section 244, 245, 247, the ALU 240, and the control unit 239 in the processor 205 working together to perform the fetch, decode, and execute cycles for every instruction in the instruction set for the noted segments of the program 233.

It is to be understood that the structural context of the transaction portal server 110 is presented merely by way of example. Therefore, in some arrangements, one or more features of the transaction portal server 110 may be omitted. Also, in some arrangements, one or more features of the transaction portal server 110 may be combined together. Additionally, in some arrangements, one or more features of the transaction portal server 110 may be split into one or more component parts.

FIG. 9 shows an alternative implementation of the transaction portal server 110. In the alternative implementation, the transaction portal server 110 may be generally described as a physical device comprising at least one processor 902 and at least one memory 904 including computer program code. The at least one memory 904 and the computer program code are configured to, with the at least one processor 902, cause the transaction portal server 110 to perform the operations described in FIGS. 4, 5, 6, and 8. The transaction portal server 110 may also include a broadcast transaction record module 906, a payment module 908, a registered user module 910, a registered merchant module 912, and an association module 914. The memory 904 stores computer program code that the processor 902 compiles to have each of the broadcast transaction record module 906, the payment module 908, the registered user detail module 910, the registered merchant detail module 912, and the association module 912 performs their respective functions.

With reference to the discussion above regarding the user devices 130, the registered user module 910 manages the on-boarding (see the on-boarding discussion above) and storing of users who are consumers who wish to buy products from registered merchants. With reference to the discussion above regarding the merchant devices 120, the registered merchant module 912 manages the on-boarding (see the on-boarding discussion above) and storing of merchants which offer products for sale.

With reference to FIG. 1, the broadcast transaction record module 906 receives a request (see step 310 of FIG. 3 discussed above) from the merchant devices 120 to broadcast a transaction record and stores data relating to broadcast transaction records. The broadcast transaction record module 906 also transmits (see step 314 of FIG. 3 discussed above), to the user devices 130 and the media devices 150, broadcast transaction records and/or transaction identifiers associated with the broadcast transaction records.

With reference to FIG. 1, the association module 914 manages the association between broadcast transaction records stored in the broadcast transaction record module 906 and registered users stored in the registered user module 910. The method 400 (discussed above) describes the method of associating a user account of a registered user with a broadcast transaction record.

With reference to FIG. 1, the payment module 908 creates a transaction request message and manages the transmission of the transaction request message to the acquirer server 138. For example, the payment module 908 manages the steps 325, 326, and 328 of FIG. 5 (discussed above) when the transaction portal server 110 interacts with the acquirer server 138.

The arrangements described are applicable to the computer and data processing industries and particularly for the payment technology.

The foregoing describes only some embodiments of the present invention, and modifications and/or changes can be made thereto without departing from the scope and spirit of the invention, the embodiments being illustrative and not restrictive.

1. A system for processing a transaction, the system comprising:
at least one processor; and
at least one memory including computer program code;
the at least one memory and the computer program code configured to, with the at least one processor, cause the system at least to:
receive, from a user device, a transaction pairing request, the transaction pairing request comprising user account information of a user account;
transmit, to a receiving device, a plurality of transaction identifiers based on the transaction pairing request;
receive, from the user device, a selection of one of the plurality of transaction identifiers; and
associating the user account with a transaction record indicated by the selection of one of the plurality of transaction identifiers.

2. The system of claim 1, wherein the transaction pairing request comprises a filter parameter, the filter parameter being any one of location information, merchant details, and time information.

3. The system of claim 1 or 2, wherein the at least one memory and the computer program code is further configured with the at least one processor to:
forward, to a merchant device, the transaction pairing request; and
receive, from the merchant device, a pairing response indicating whether the transaction pairing request is approved.

4. The system of claim 1, wherein the at least one memory and the computer program code is further configured with the at least one processor to:
initiate a payment to transfer a fund relating to an amount for a product indicated in the transaction record in response to receiving a payment request.

5. The system of any claim 1, wherein the at least one memory and the computer program code is further configured with the at least one processor to:
transmit, to the merchant device or the user device, a notification message notifying the merchant or the user respectively of whether the user account is associated with the transaction record indicated by the selection of one of the plurality of transaction identifiers.

6. The system of claim 4, wherein the at least one memory and the computer program code is further configured with the at least one processor to:
generate a payment token based on a user token of the user account and the transaction record associated with the user account; and
transmit the payment token to an acquirer server.

7. The system of claim 1, wherein the at least one memory and the computer program code is further configured with the at least one processor to:
update the transaction record associated with the user account to include a further product and an amount corresponding to the further product.

8. The system of claim 1, wherein the at least one memory and the computer program code is further configured with the at least one processor to:
receive, from a merchant device, data relating to transaction records, wherein the data includes the location information of the transaction records.

9. The system of claim 4, wherein the at least one memory and the computer program code is further configured with the at least one processor to:
receive, from the user device, a request to pay the transaction record associated with the user account;
generate a transaction request message associated with the transaction record in response to the request to pay the transaction record; and
transmit, to the acquirer server, the transaction request message.

10. A method of processing a transaction, comprising:
receiving, from a user device, a transaction pairing request, the transaction pairing request comprising user account information of a user account;
transmitting, to a receiving device, a plurality of transaction identifiers based on the transaction pairing request;
receiving, from the user device, a selection of one of the plurality of transaction identifiers; and
associating the user account with a transaction record indicated by the selection of one of the plurality of transaction identifiers.

11. The method of claim 10, wherein the transaction pairing request comprises a filter parameter, the filter parameter being any one of location information, merchant details, and time information.

12. The method of claim 10 or 11, wherein the step of determining whether to associate the user account with the product listing message indicated in a pairing request that is received from the user device comprises:
forwarding, to a merchant device, the transaction pairing request; and receiving, from the merchant device, a pairing response indicating whether the transaction pairing request is approved.

13. The method of claim 10, further comprising:
initiating a payment to transfer a fund relating to an amount for a product indicated in the transaction record in response to receiving a payment request.

14. The method of claim 10, further comprising:
transmitting, to the merchant device or the user device, a notification message notifying the merchant or the user respectively of whether the user account is associated with the transaction record indicated by the selection of one of the plurality of transaction identifiers.

15. The method of claim 13, further comprising:
generating a payment token based on a user token of the user account and the transaction record associated with the user account; and
transmitting the payment token to an acquirer server.

16. The method of claim 10, further comprising:
updating the transaction record associated with the user account to include a further product and an amount corresponding to the further product.

17. The method of claim 10, further comprising:
receiving, from a merchant device, data relating to transaction records, wherein the data includes the location information of the transaction records.

18. The method of claim 13, wherein the step of initiating a payment to transfer a fund comprises:
receiving, from the user device, a request to pay the transaction record associated with the user account;
generating a transaction request message associated with the transaction record in response to the request to pay the transaction record; and
transmitting, to the acquirer server, the transaction request message.

19. A non-transitory computer program product having software application programs that are executable by a processor, such that the processor executes the software application programs to perform a method of processing a transaction, the method comprising:
receiving, from a user device, a transaction pairing request, the transaction pairing request comprising user account information of a user account;
transmitting, to a receiving device, a plurality of transaction identifiers based on the transaction pairing request;
receiving, from the user device, a selection of one of the plurality of transaction identifiers; and
associating the user account with a transaction record indicated by the selection of one of the plurality of transaction identifiers.

20. The non-transitory computer program product of claim 19, wherein the transaction pairing request comprises a filter parameter, the filter parameter being any one of location information, merchant details, and time information.
